(19) United States
(12) Patent Application Publication
(10) Pub. No.: US 2026/0146644 A1
(43) Pub. Date: May 28, 2026

(54) BUSH AND SEAT FRAME

(71) Applicant: TOYOTA BOSHOKU KABUSHIKI KAISHA, Aichi (JP)

(72) Inventors: Masaya SHIBATA, Kitanagoya-shi (JP); Takuya INOUE, Toyota-shi (JP)

(73) Assignee: TOYOTA BOSHOKU KABUSHIKI KAISHA, Aichi (JP)

(21) Appl. No.: 19/400,107

(22) Filed: Nov. 25, 2025

(30) Foreign Application Priority Data
Nov. 28, 2024 (JP) 2024-207351

(51) Int. Cl. F16C 17/02; B60N 2/16; B60N 2/90

(52) U.S. Cl. CPC F16C 17/02; B60N 2/90; B60N 2/165; F16C 2326/08

(57) ABSTRACT

Provided is a bush. The bush is configured as an annular slide bearing and extends along an axis. The bush includes a cylindrical portion and a cut. The cylindrical portion extends along the axis. The cut having a thread-like shape extends linearly from a first end to a second end of the bush in an axial direction and serves to separate the bush in a circumferential direction. The cut includes a blocking portion. The blocking portion is formed on the cylindrical portion and configured to inhibit passage of an object through the cut.

### CROSS-REFERENCE TO RELATED APPLICATIONS

This application claims the benefit of Japanese Patent Application No. 2024-207351 filed on Nov. 28, 2024 with the Japan Patent Office, the entire disclosure of which is incorporated herein by reference.

### BACKGROUND

The present disclosure relates to a bush and a seat frame.

Japanese Unexamined Patent Application Publication No. 2015-067136 discloses a bush attached to a seat frame of a vehicle. The bush is a cylindrical member extending along an axis and configured as a slide bearing.

### SUMMARY

The aforementioned bush is formed, for example, by deforming a metal plate, which extends along a longitudinal direction, such that both end faces thereof are in contact with each other. The bush has a cut that extends straightly from a first end to a second end of the bush in an axial direction and serves to separate the bush in a circumferential direction.

For example, in a process of manufacturing a seat frame, one bush may be picked up from a plurality of bushes heaped up and then mounted to the seat frame. If bushes each having a cut as described above are heaped up, there is a possibility that the cut of one of the bushes may allow passage of another bush therethrough, resulting in the bushes becoming entangled with one another (i.e., a state in which each of two bushes passes through an interior of the other). Accordingly, when attempting to take out one bush from among the plurality of bushes, there is a possibility that some bushes entangled with one another may be taken out altogether, thus reducing work efficiency.

In one aspect of the present disclosure, it is desirable to inhibit passage of an object through the cut of the bush. In one example, the object described herein is another bush. However, the present disclosure is not limited thereto, and the object may be any article that can become entangled with a bush when passing through a cut of the bush. For example, the object may be a thin plate-like member such as a washer, or a linear member such a wire harness.

One aspect of the present disclosure is to provide an annular bush configured as a slide bearing, extending along an axis. The bush comprises a cylindrical portion and a cut. The cylindrical portion extends along the axis. The cut having a thread-like shape extends from the first end to the second end of the bush in an axial direction and serves to separate the bush in the circumferential direction. The cut includes a blocking portion that is formed on the cylindrical portion and configured to obstruct passage of the object through the cut.

In the aforementioned configuration, the blocking portion can obstruct passage of the object through the cut. Accordingly, it is possible to inhibit passage of the object through the cut of the bush.

In one aspect of the present disclosure, the cut may include a first portion and a second portion. The first portion extends from the first end toward the second end of the bush in a direction substantially aligning with the axial direction. The second portion extends from the second end toward the first end of the bush in the direction substantially aligning with the axial direction. In the second portion, an end on the first end side may be located at a position in the circumferential direction that is distinct from a position of an end of the first portion on the second end side. The blocking portion may extend in a bending manner from the end of the first portion on the second end side to the end of the second portion on the first end side.

With the aforementioned configuration, it is possible to effectively inhibit passage of the object through the cut of the bush.

In one aspect of the present disclosure, the blocking portion may extend along a bent path protruding toward a first side in the circumferential direction.

With the aforementioned configuration, it is possible to effectively inhibit passage of the object through the cut of the bush.

In one aspect of the present disclosure, the cylindrical portion may be inserted into a through-hole that penetrates a side frame in a seat-width direction, the side frame being located at an end of a cushion frame of a vehicle seat in the seat-width direction. Furthermore, the cylindrical portion may rotatably support a rod member, which is inserted therein, with respect to the side frame.

With the aforementioned configuration, it is possible to inhibit passage of the object through the cut of the bush. Accordingly, it is possible to restrain a reduction in work efficiency during installation of the bush in the seat frame.

One aspect of the present disclosure is to provide the above-described seat frame used in a vehicle seat, the seat frame comprising the above-described bush.

With the aforementioned configuration, it is possible to inhibit passage of the object through the cut of the bush. Accordingly, it is possible to restrain a reduction in work efficiency during installation of the bush in the seat frame.

### BRIEF DESCRIPTION OF THE DRAWINGS

Example embodiments of the present disclosure will be described hereinafter with reference to the accompanying drawings, in which:

FIG. 1A is a perspective view of a bush in a first embodiment;

FIG. 1B is a perspective view of the bush in the first embodiment;

FIG. 1C is a perspective view of a bush in a modified example;

FIG. 1D is a perspective view of the bush in the modified example;

FIG. 2 is a perspective view of a seat frame; and

FIG. 3 is a cross-sectional view, taken along a direction perpendicular to a front-rear direction, of a portion of the seat frame at which a lower arm and a first rod are coupled to each other.

### DETAILED DESCRIPTION OF EXEMPLARY EMBODIMENTS

### 1. Overview

### 1-1. Bush

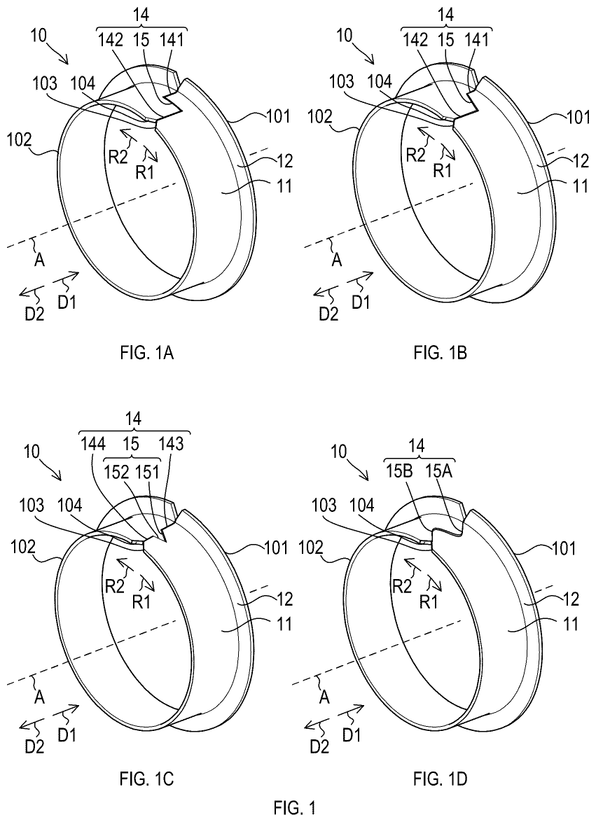

In the present embodiment, a bush 10 is configured as a slide bearing having an annular shape and extending along an axis A (see FIG. 1). The bush 10 is, in one example, attached to a seat frame 1, which will be described later. However, the present disclosure is not limited to this, and the bush 10 may be used for other purposes.

The bush 10 comprises a cylindrical portion 11, a first flange 12, and a cut 14.

The cylindrical portion 11 has a tubular shape extending along the axis A. The first flange 12 protrudes radially outward from a first end of the cylindrical portion 11 in a direction along the axis A (hereinafter, referred to as the axial direction). Hereinafter, in the bush 10, a side on which the first flange 12 is located relative to the cylindrical portion 11 in the axial direction is defined as a first side D1, and a side opposite to the first side D1 is defined as a second side D2. Furthermore, in the bush 10, an end on the first side D1 in the axial direction is defined as a first end 101, and an end on the second side D2 is defined as a second end 102.

The cut 14 having a thread-like shape extends from the first end 101 of the bush 10 in the axial direction (hereinafter, simply referred to as the first end 101) to the second end 102 of the bush 10 in the axial direction (hereinafter, simply referred to as the second end 102) and serves to circumferentially separate the bush 10. That is, at least a part of the cut 14 is formed on the cylindrical portion 11.

The bush 10 comprises a first peripheral surface 103 and a second peripheral surface 104 that are formed from the first end 101 to the second end 102 of the bush 10 to extend in an elongated manner. The first peripheral surface 103 and the second peripheral surface 104 face each other throughout their entire extent. The cut 14 is formed by a clearance between the first peripheral surface 103 and the second peripheral surface 104. Hereinafter, in a vicinity of the cut 14 of the bush 10, a side on which the first peripheral surface 103 is located relative to the second peripheral surface 104 in a circumferential direction is referred to as a first side R1, and a side opposite to the first side R1 is referred to as a second side R2. Peripheral portions of both ends of each of the first peripheral surface 103 and the second peripheral surface 104 extend in a bending manner toward the first side R1 and the second side R2, respectively, such that a distance between the first peripheral surface 103 and the second peripheral surface 104 increases toward the ends.

The cut 14 includes a first portion 141, a second portion 142, and a blocking portion 15 (see FIGS. 1A and 1B). The first portion 141 extends from the first end 101 of the bush 10 toward the second side D2 along the axial direction. The second portion 142 extends from the second end 102 of the bush 10 toward the first side D1 along the axial direction. An end of the second portion 142 on the first side D1 is located at a position circumferentially different from a position where an end of the first portion 141 on the second side D2 is located. Specifically, in the present embodiment, the end of the second portion 142 on the first side D1 is positioned on the first side R1 in the circumferential direction relative to the end of the first portion 141 on the second side D2.

The blocking portion 15 is formed in the cylindrical portion 11 and extends straightly from the end of the first portion 141 on the second side D2 to the end of the second portion 142 on the first side D1 to run perpendicular to the first and second portions 141, 142 (see FIG. 1A). Specifically, the blocking portion 15 extends circumferentially along the cylindrical portion 11.

It is to be noted that the present disclosure is not limited thereto, and the angle at which the blocking portion 15 and each of the first and second portions 141, 142 intersect may be an obtuse angle (i.e., an angle greater than 90 degrees) (see FIG. 1B), or an acute angle (i.e., an angle less than 90 degrees). The blocking portion 15 may extend in a curved manner.

In the cut 14 configured as above, the blocking portion 15 is bent relative to the first and second portions 141, 142. Therefore, compared to a case in which the cut 14 extends straightly over its entire length, passage of another bush through the cut 14 can be more effectively inhibited. Specifically, the blocking portion 15 is configured to obstruct passage of an object through the cut 14.

### Modified Examples

(1) The blocking portion 15 may extend along an angled path configured to project toward the first side R1 in the circumferential direction. Specifically, for example, the cut 14 may include third and fourth portions 143, 144, which are configured as described below, and the blocking portion 15 (see FIG. 1C).

The third portion 143 extends from the first end 101 of the bush 10 toward the second side D2 along the axial direction. The fourth portion 144 extends from the second end 102 of the bush 10 toward the first side D1 along the axial direction. The fourth portion 144 is positioned at the same circumferential location as the third portion 143.

The blocking portion 15 includes a fifth portion 151 and a sixth portion 152 (see FIG. 1C). The fifth portion 151 extends obliquely with respect to the axial direction from an end of the third portion 143 on the second side D2 toward the second side D2 while extending toward the first side R1 in the circumferential direction. The sixth portion 152 extends obliquely with respect to the axial direction, from an end of the fifth portion 151 on the second side D2 to an end of the fourth portion 144 on the first side D1, while extending toward the second side D2 and toward the second side R2 in the circumferential direction. Specifically, the blocking portion 15 extends from the end of the third portion 143 on the second side D2 to the end of the fourth portion 144 on the first side D1 along a bent path that projects toward the first side R1 in the circumferential direction. However, the present disclosure is not limited hereto, and the blocking portion 15 may extend along a curved path that projects toward the first side R1 in the circumferential direction.

(2) Furthermore, the cut 14 may include a plurality of the blocking portions 15. Specifically, for example, the cut 14 may include a first blocking portion 15A and a second blocking portion 15B (see FIG. 1D).

The first blocking portion 15A extends from the first end 101 of the bush 10 toward the second side D2 along a curved path that projects toward the first side R1 in the circumferential direction. The second blocking portion 15B extends from the second end 102 of the bush 10 toward the first side D1 along a curved path that projects toward the second side R2 in the circumferential direction. An end of the first blocking portion 15A on the second side D2 and an end of the second blocking portion 15B on the first side D1 are connected.

With the cut 14 configured as described in the modified examples (1) and (2), it is possible to more effectively inhibit, compared to a case in which the cut 14 extends straightly over its entire length, passage of the object (for example, another bush) through the cut 14. Specifically, the blocking portion 15 is configured to obstruct passage of the object through the cut 14.

### 1-2. Seat Frame

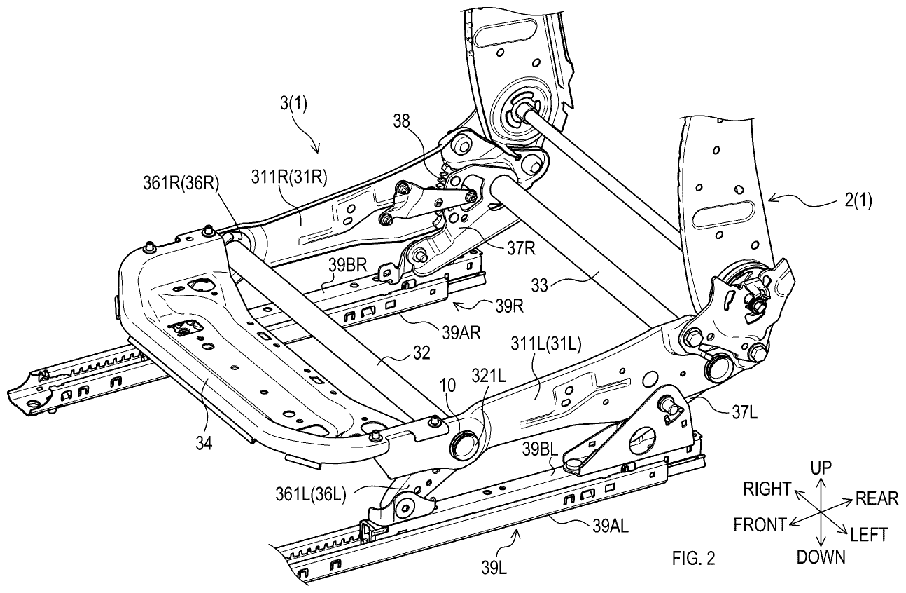

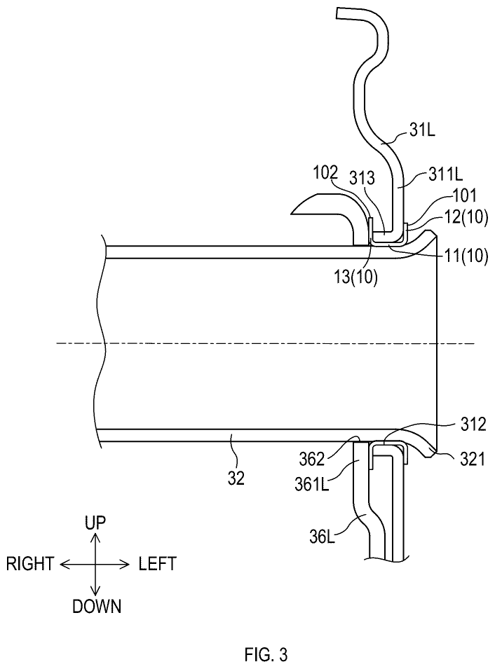

The seat frame 1 according to the present embodiment is used, in one example, in a vehicle seat (see FIGS. 2 and 3). In one example, the vehicle seat is used as a seat for a passenger car. The directions in the following description and each drawing refer to the directions of the vehicle seat mounted in the vehicle (i.e., the passenger car). In the present embodiment, the vehicle seat is mounted such that, in one example, a seat-width direction corresponds to a right-left direction of the vehicle, a seat up-down direction corresponds to an up-down direction of the vehicle, and a seat front-rear direction corresponds to a front-rear direction of the vehicle. Hereinafter, the right-left direction of the vehicle, the up-down direction of the vehicle, and the front-rear direction of the vehicle will be referred to simply as the right-left direction, the up-down direction, and the front-rear direction, respectively. Furthermore, in the seat frame 1, a side on which left and right ends thereof are positioned relative to a central portion in the right-left direction is referred to as an outer side, and a side opposite to the outer side is referred to as an inner side.

The seat frame 1 comprises a back frame 2 and a cushion frame 3 (see FIG. 2). The back frame 2 forms a framework of a seatback. The seatback supports a back of an occupant on the vehicle seat. The cushion frame 3 forms a framework of a seat cushion. The seat cushion supports buttocks of the occupant on the vehicle seat. The back frame 2 is coupled to rear end portions of two lower arms 31 of the cushion frame 3, which will be described below.

The cushion frame 3 comprises two side frames (hereinafter, referred to as lower arms) 31R and 31L, a first rod 32, a second rod 33, and a front panel 34.

The two lower arms 31R and 31L are provided on left and right sides of the cushion frame 3 and extend in the front-rear direction. The lower arm 31R is provided on the right side, and the lower arm 31L is provided on the left side. In the description hereinafter, as with the lower arms, elements provided on the right side are denoted with the symbol “R”, and those on the left side are denoted with the symbol “L”. The lower arm 31R and the lower arm 31L respectively comprise a plate portion 311R and a plate portion 311L, both of which extend in the front-rear direction. The two plate portions 311R and 311L face each other in the right-left direction.

The first rod 32 is provided at a front end portion of the cushion frame 3 and has a cylindrical shape extending in the right-left direction. The first rod 32 is rotatably coupled to front end portions of the two lower arms 31R and 31L. The first rod 32 is fixed to two front lifter links 36R and 36L, which will be described below.

The second rod 33 is provided at a rear end portion of the cushion frame 3 and has a cylindrical shape extending in the right-left direction. The second rod 33 is rotatably coupled to rear end portions of the two lower arms 31R and 31L and fixed to two rear lifter links 37R and 37L, which will be described below.

The front panel 34 has a plate-like shape and is arranged in a front end area of the cushion frame 3. The front panel 34 is coupled, at both ends in the right-left direction, to the front end portions of the two lower arms 31R and 31L.

The seat frame 1 according to the present embodiment comprises the two front lifter links 36R and 36L, the two rear lifter links 37R and 37L, a sector gear 38, and two slide rails 39R and 39L (see FIG. 2). The two front lifter links 36R and 36L, the two rear lifter links 37R and 37L, and the sector gear 38 enable the cushion frame 3 to be displaced in the up-down direction.

Each of the two front lifter links 36R and 36L is provided on a respective side of the seat frame 1 in the right-left direction. The front lifter link 36R and the front lifter link 36L respectively include a plate portion 361R and a plate portion 361L, both of which extend in a longitudinal direction. The two plate portions 361R and 361L face each other in the right-left direction. Each of the two plate portions 361R and 361L is rotatably coupled, at a first end, to a front end portion of each of upper rails 39BR and 39BL of two slide rails 39R and 39L, which will be described below. Each of the two plate portions 361R and 361L is fixed, at a second end, to a peripheral portion of each end of the first rod 32.

Each of the two rear lifter links 37R and 37L is provided on a respective side of the seat frame 1 in the right-left direction and extends in the longitudinal direction. The rear lifter links 37R and 37L are located rearward of the front lifter links 36R and 36L. Each of the two rear lifter links 37R and 37L is rotatably coupled, at a first end, to a rear end portion of each of the upper rails 39BR and 39BL of two slide rails 39R and 39L, which will be described below. Each of the two rear lifter links 37R and 37L is fixed, at a second end, to a peripheral portion of each end of the second rod 33.

The sector gear 38 is fixed to the rear lifter link 37R on the right side. As the sector gear 38 rotates about an axis of the second rod 33, the rear lifter link 37R, to which the sector gear 38 is fixed, rotates accordingly, and in conjunction therewith, the other rear lifter link 37L (i.e., the one on the left side) and the two front lifter links 36R and 36L rotate. This causes the cushion frame 3 to be displaced in the up-down direction.

The two slide rails 39R and 39L enable the cushion frame 3 to be displaced in the front-rear direction. The slide rail 39R and the slide rail 39L are provided below the lower arm 31R and the lower arm 31L, respectively, and extend in the front-rear direction. The slide rail 39R and the slide rail 39L respectively include a lower rail 39AR and a lower rail 39AL, both of which extend in the front-rear direction and are fixed to the vehicle. The slide rail 39R and the slide rail 39L respectively include the upper rail 39BR and the upper rail 39BL, each of which extends in the front-rear direction and is slidable in the front-rear direction with respect to the lower rail 39AR and the lower rail 39AL.

### Structure of Coupling portion in First Rod

Descriptions will be given of a structure of the portion at which the lower arms 31R and 31L and the first rod 32 in the present embodiment are coupled (hereinafter, the coupling portion) (see FIGS. 2 and 3). The coupling portion on the left side and the coupling portion on the right side have symmetrical structures. Hereinafter, a structure of the coupling portion on the left side (i.e., the portion at which the lower arm 31L and the first rod 32 is coupled) will be described by way of example.

In the lower arm 31L, the plate portion 311L is provided with a through-hole 312 in a circular shape that penetrates the plate portion 311L in the right-left direction (see FIG. 3). Furthermore, the plate portion 311L of the lower arm 31L is provided with a projection 313 having a cylindrical shape that surrounds the through-hole 312 and projects inward from an edge on an inner surface of the plate portion 311L. The projection 313 includes a top portion having a top surface extending flatly. In one example, the projection 313 is formed by performing a burring process on the through-hole 312 of the plate portion 311L.

The bush 10 is inserted into the through-hole 312. The bush 10 is arranged such that its axial direction aligns with the right-left direction, with the first end 101 positioned on the outer side and the second end 102 positioned on the inner side. The cylindrical portion 11 of the bush 10 is in contact, at its outer circumferential surface, with an inner circumferential surface of the through-hole 312.

The bush 10 is provided, at the second end 102 (i.e., the end on the inner side), with a second flange 13 that is formed through a swaging process, which is described below. The first flange 12 is contact, at its inner surface, with an outer surface of the plate portion 311L, and the second flange 13 is in contact, at its outer surface, with the top surface of the projection 313 (specifically, the surface on the inner side). Specifically, the first and second flanges 12, 13 hold the lower arm 31L from both sides in the right-left direction. This restricts displacement of the bush 10 relative to the lower arm 31L in the right-left direction.

The plate portion 361L of the front lifter link 36L is located inward from the plate portion 311L of the lower arm 31L. The plate portion 361L of the front lifter link 36L is in contact, at its outer surface, with an inner surface of the second flange 13 of the bush 10.

Furthermore, the front lifter link 36L is provided with a through-hole 362 in a circular shape penetrating the plate portion 361L in the right-left direction. The through-hole 362 of the front lifter link 36L is aligned with the through-hole 312 of the lower arm 31L.

The first rod 32 is inserted into the bush 10 and the through-hole 362 of the front lifter link 36L. The first rod 32 is fixed to the front lifter link 36L and, with the bush 10 functioning as a slide bearing, is rotatable relative to the lower arm 31L. A left end portion of the first rod 32 is located on the left side of (i.e., outward from) the plate portion 311L of the lower arm 31L.

The first rod 32 includes, at an area located outward from the plate portion 311L of the lower arm 31L, an enlarging diameter portion 321 whose diameter increases toward the outer side. An outer circumferential surface of the enlarging diameter portion 321 and the outer surface of the plate portion 361L of the front lifter link 36L hold the bush 10 from both sides in the right-left direction. This restricts displacement of the first rod 32 relative to the lower arm 31L in the right-left direction.

### Steps to Install the First Rod

The first rod 32 is installed on the lower arm 31L and the front lifter link 36L through the following steps (see FIGS. 2 and 3).

First, the bush 10 is inserted from the second end 102 into the through-hole 312 of the lower arm 31L, in a direction from the outer side to the inner side. This causes a surface of the first flange 12 on the second side D2 (i.e., the inner side) to come into contact with the outer surface of the plate portion 311L.

Next, the swaging process is performed on the bush 10. Specifically, an inner circumferential surface of a portion of the cylindrical portion 11 of the bush 10 located on the second side D2 (i.e., the inner side) relative to the projection 313 is pressed and expanded radially outward. As a result, the portion is bent in a radially outwardly protruding manner, thereby forming the second flange 13 on the bush 10. This causes a surface of the second flange 13 on the first side D1 (i.e., the outer side) to come into contact with the top surface of the projection 313 (specifically, an end face on the inner side).

Next, the front lifter link 36L is arranged such that the through-hole 362 aligns with the through-hole 312 of the lower arm 31L. The outer surface of the plate portion 311L of the front lifter link 36L is caused to come into contact with the inner surface of the first flange 12.

Next, the first rod 32 is inserted into the bush 10 and the through-hole 362 of the front lifter link 36L. During this step, the left end portion of the first rod 32 is located outward from the plate portion 311L of the lower arm 31L.

Next, a welding is performed to join an outer circumferential surface of the first rod 32 to an edge of an inner surface of the through-hole 362 of the front lifter link 36L, the edge surrounding an opening. Through this welding, the first rod 32 is fixed to the front lifter link 36L.

Then, an inner circumferential surface of a portion of the first rod 32 located outward from the plate portion 311L of the lower arm 31L is pressed and expanded radially outward. As a result, a diameter of the portion is increased, thereby forming the enlarging diameter portion 321 in the first rod 32.

### 2. Effects

The present embodiment detailed above can bring the following effects.

(1) In the present embodiment, the cut 14 of the bush 10 comprises the blocking portion 15 configured to obstruct passage of the object through the cut 14. Accordingly, it is possible to inhibit, compared to a case in which the cut 14 extends straightly over its entire length, passage of another bush through the cut 14. Thus, it is possible to inhibit a situation in which, for example, when attempting to take out one bush from among a plurality of heaped bushes, some bushes entangled with one another may be taken out altogether. Accordingly, it is possible to restrain a reduction in work efficiency during installation of the bush 10 in the seat frame 1.

(2) When the cut 14 of the bush 10 extends along the axial direction over its entire length, the following concerns may arise. Specifically, the bush 10 may deform when an external force that causes the first and second peripheral surfaces 103, 104 forming the cut 14 in the bush 10 to undergo a relative displacement in the axial direction is applied to the bush 10.

On the other hand, the blocking portion 15 of the bush 10 according to the aforementioned embodiment extends in a bending manner relative to the axial direction. Accordingly, when the above-described external force is applied to the bush 10, portions of the first and second peripheral surfaces 103, 104 adjacent to the blocking portion 15 come into contact with each other, thereby inhibiting further deformation of the bush 10.

(3) In a case in which the cut 14 of the bush 10 extends along the axial direction over its entire length, the following concerns may arise. Specifically, when the bush 10 is inserted into the through-hole 312 of the lower arm 31L, the bush 10 before undergoing the swaging process may be displaced outward from the lower arm 31L, resulting in misalignment of the bush 10 from the through-hole 312.

On the other hand, the blocking portion 15 of the bush 10 according to the aforementioned embodiment extends in a bending manner relative to the axial direction. Accordingly, when the bush 10 is about to be displaced outward of the lower arm 31L, a corner located at radially outer ends of the portions of the first and second peripheral surfaces 103, 104 adjacent to the blocking portion 15 is caught on the inner circumferential surface of the through-hole 312, thereby inhibiting such a displacement. Accordingly, it is possible to inhibit misalignment of the bush 10 before undergoing the swaging process from the through-hole 312.

(4) In a case in which the cut 14 of the bush 10 extends along the axial direction over its entire length, the following concerns may arise. Specifically, when the bush 10 is installed in the seat frame 1 in the above-described manner, the cut 14 forms a clearance (hereinafter, referred to as a play), between the outer circumferential surface of the first rod 32 and the through-hole 312 of the lower arm 31L, that extends along the axial direction over its entire length. Due to the play, the first rod 32 may be displaced radially relative to the bush 10 (in other words, the first rod 32 may shake in the radial direction).

On the other hand, the blocking portion 15 of the bush 10 according to the aforementioned embodiment extends in a bending manner relative to the axial direction. Accordingly, when the aforementioned bush 10 is installed in the seat frame 1 in the above-described manner, occurrence of play can be reduced. Accordingly, it is possible to reduce radial play of the first rod 32.

### 3. Correspondence between Terms

In the present embodiment, the first rod 32 corresponds to one example of a rod member.

### 4. Other Embodiments

The above has described the embodiment according to the present disclosure. However, it goes without saying that the present disclosure is not limited to the aforementioned embodiment and may be embodied in various forms.

(1) In the aforementioned embodiment, the first flange 12 of the bush 10 is located inward from the plate portion 311L, and the second flange 13 is located outward of the plate portion 311L. However, the present disclosure is not limited thereto. The present disclosure may have a configuration in which: the first flange 12 of the bush 10 is located inward from the plate portion 311L, and the second flange 13 is located outward from the plate portion 311L. Furthermore, the outer surface of the first flange 12 may be in contact with the top surface of the projection 313 (specifically, the end face on the inner side), and the inner surface of the second flange 13 may be in contact with the outer surface of the plate portion 311L.

The aforementioned bush 10 may be installed in the lower arm 31L through the following steps. Specifically, the bush 10 may be inserted from the second end 102 into the through-hole 312 of the lower arm 31L, in a direction from the inner side to the outer side. This may cause the surface of the first flange 12 on the second side D2 (i.e., the outer side) to come into contact with the top surface of the projection 313 (specifically, the end face on the inner side). An inner circumferential surface of a portion of the cylindrical portion 11 of the bush 10 located outward from the plate portion 311L may be pressed and expanded radially outward through the swaging process, to thereby form the second flange 13. The surface of the second flange 13 on the first side D1 (i.e., the inner side) may be in contact with the outer surface of the plate portion 311L.

In the bush 10 installed in each of the lower arms 31R and 31L through the aforementioned steps, the angle at which the blocking portion 15 and each of the first and second portions 141, 142 intersect may be an obtuse angle (see FIG. 1B). In such a configuration, it is possible to more effectively inhibit, compared to a case in which the angle is a right angle, catching of the blocking portion 15 on a corner located at an inner end of the inner circumferential surface of the through-hole 312 when the bush 10 is inserted from the second end 102 into the through-hole 312, in a direction from the inner side to the outer side. Accordingly, it is possible to restrain a reduction in work efficiency during installation of the bush 10 in the seat frame 1.

(2) In the aforementioned embodiment, the bush 10 is provided at each of the coupling portions between the lower arms 31R and 31L and the first rod 32. However, the present disclosure is not limited thereto. For example, the bush 10 may be provided at each of coupling portions between the lower arms 31R and 31L and the second rod 33 in place of the aforementioned coupling portion. Alternatively, the bush 10 may be provided at each of the coupling portions between the first rod 32 and the lower arms 31R and 31L, and at each of the coupling portions between the second rod 33 and the lower arms 31R and 31L.

In the aforementioned embodiment, the vehicle seat comprising the seat frame 1 is used in a passenger car. However, the present disclosure is not limited by such an application. The vehicle seat may be, for example, used in an automobile other than a passenger car or may be used in a vehicle other than an automobile, such as a railroad vehicle, a ship, or an aircraft.

(4) Two or more functions achieved by one element in the aforementioned embodiment may be achieved by two or more elements; and one function achieved by one element may be achieved by two or more elements. Two or more functions achieved by two or more elements in the aforementioned embodiment may be achieved by one element; one function achieved by two or more elements may be achieved by one element. A part of the configuration of the aforementioned embodiments may be omitted. At least a part of the configuration of the aforementioned embodiments may be added to, or replaced with, the configuration of other embodiments described above.

What is claimed is:

1. A bush configured to function as an annular slide bearing and to extend along an axis,
the bush comprising:
a cylindrical portion that extends along the axis; and
a cut having a thread-like shape that extends from a first end to a second end of the bush in an axial direction and serves to separate the bush in a circumferential direction,
the cut including a blocking portion,
the blocking portion being formed on the cylindrical portion and configured to inhibit passage of an object through the cut.

2. The bush according to claim 1,
wherein the cut includes:
a first portion that extends from the first end toward the second end of the bush in a direction substantially aligning with the axial direction; and
a second portion that extends from the second end toward the first end of the bush in the direction substantially aligning with the axial direction,
wherein, in the second portion, an end on a first end side is located at a position in the circumferential direction that is distinct from a position of an end of the first portion on a second end side, and
wherein the blocking portion extends in a bending manner from the end of the first portion on the second end side to the end of the second portion on the first end side.

3. The bush according to claim 1,
wherein the blocking portion extends along a bent path protruding toward a first side in the circumferential direction.

4. The bush according to claim 1,
wherein the cylindrical portion is inserted into a through-hole that penetrates a side frame in a seat-width direction and rotatably supports a rod member, which is inserted therein, with respect to the side frame, the side frame being located at an end of a cushion frame of a vehicle seat in the seat-width direction.

5. A seat frame used in a vehicle seat,
the seat frame comprising:
a bush configured to function as an annular slide bearing and to extend along an axis; and
a cushion frame including a rod member and a side frame that is located at an end of the cushion frame in a seat-width direction,
the bush comprising:
a cylindrical portion that extends along the axis; and
a cut having a thread-like shape that extends from a first end to a second end of the bush in an axial direction and serves to separate the bush in a circumferential direction,
the cut including a blocking portion,
the blocking portion being formed on the cylindrical portion and configured to inhibit passage of an object through the cut,
the cylindrical portion being inserted into a through-hole that penetrates the side frame in the seat-width direction,
the rod member being inserted in the cylindrical portion and rotatably supported with respect to the side frame.
